(19) United States
(12) Patent Application Publication
(10) Pub. No.: US 2007/0290511 A1
(43) Pub. Date: Dec. 20, 2007

(54) Mortise lock for a sliding door

(76) Inventors: Luke Liang, South Plainfield, NJ (US); Toni Liang, Guangzhou (CN); David Chen, Guangzhou (CN)

Correspondence Address: Thomas A. O'Rourke;Bodner & O'Rourke, LLP, 425 Broadhollow Road, Melville, NY, 11747, US

(21) Appl. No.: 11/447,667

(22) Filed: Jun. 6, 2006

(51) Int. Cl. E05C 19/10

(52) U.S. Cl. 292/24

(57) ABSTRACT

The two-point mortise latch of the present invention includes, a central actuator having teeth that are meshed with the teeth of a gear wheel, wherein the gear wheel and the central actuator are pivotally connected to at least one hook, via the hook arm. Wherein the top and bottom surfaces of the hooks have guide protrusions that are set in a guide their respective guide areas. The hooks are designed to contact the bottom interior surface of the keeper housing when latched. The central actuator and gear are meshed together via teeth. In addition, the central actuator and gear wheel are biased with springs so as to facilitate opening and closing of the door latch. The components of the present invention are retained inside of the housing, which is set inside the lock stile of a door.

### FILED OF THE INVENTION

The present invention relates to sliding door locks in particular sliding door locks, which implement a two point mortise.

### BACKGROUND OF THE INVENTION

Mortise locks and latches have been implemented for over a century. Generally, mortise locks and latches require a rectangular hole in the door edge for installation, and for all intensive purposes are identical, the only difference is that a mortise lock actually locks whereas a mortise latch only latches. The present invention is compatible with either type of mortise door system. For the purposes of brevity a mortise latch will be described only, keeping in mind that the present invention may be used with a mortise lock just as easy.

A mortise latch (mortice lock in British English) is one that requires a pocket—the mortise—to be cut into the door or piece of furniture into which the lock is to be fitted. In most parts of the world, mortise latches are generally found on older buildings constructed before the advent of bored cylindrical locks, but they have recently become more common in commercial and up market residential construction in the United States. The parts included in the typical mortise lock installation are the lock body (the part installed inside the mortise cut-out in the door); the lock trim (which may be selected from any number of designs of doorknobs, levers, handle sets and pulls); a strike plate, or a box keep, which lines the hole in the frame into which the bolt fits; and the keyed mortise cylinder which operates the locking/unlocking function of the lock body. However, in the United Kingdom, and certain other countries, most mortise locks on dwellings do not use cylinders, but have lever tumbler mechanisms. The installation of a mortise latch cannot generally be undertaken by the average homeowner since it is labor intensive and requires a working knowledge of basic woodworking tools and methods. Many installation specialists use a mortising jig which makes precise cutting of the pocket a simple operation, but the subsequent installation of the external trim can still prove problematic if the installer is inexperienced. Although the installation of a mortise latch actually weakens the structure of the typical timber door, a mortise latch does offer more versatility than a bored cylindrical latch, both in external trim, and functionality. Whereas the latter mechanism lacks the architecture required for ornate and solid-cast knobs and levers, the mortise latch can accommodate a heavier return spring and a more solid internal mechanism, making their use possible. Furthermore, a mortise lock will typically accept a wide range of other manufacturers' cylinders and accessories, allowing architectural conformity with lock hardware already on site. Some of the most common manufacturers of mortise locks in the United States are Baldwin, Emtek, Falcon, Schlage, and Sargent. Also, many European manufacturers whose products had been restricted to “designer” installations have recently gained wider acceptance and use.

Typical mortise latches or locks are offered in a complete range of functions designed for commercial and institutional applications. They are engineered for strength and performance, and precisely manufactured to exacting standards. Components are interchangeable for functionality and versatility. Some mortise locks are designed with high quality components to provide high security, performance and durability. They are well suited for commercial facilities with exposed perimeter doors, such as warehouses, factories and malls. Other facilities that may implement mortise door locks are hospitals, schools, universities, factories, and office buildings. Still other mortise door locks are designed for use on those openings that are subjected to expected extreme abuse, vandalism, and malicious impact, such as in asylums, detention centers, commercial facilities with exposed perimeter doors as in warehouses and malls.

### OBJECTS OF INVENTION

It is an object of the present invention to provide a mortise door lock that is easy, and cost effective to manufacture.

It is an object of the present invention to provide a mortise lock that is easy to install.

It is an object of the present invention to provide an improved mortise lock which offers added security and performance over other two-point mortise locking systems.

It is another object of the invention to provide an improved mortise lock having a single actuator which may deploy two locking hooks simultaneously.

It is still another object of the present invention to provide an improved mortise lock that will not require a large bored cavity fro installation.

These and other objects of the present invention will become apparent to those skilled in the art from a review from the description provided below.

### SUMMARY OF INVENTION

The instant invention is structured around the concept of controlling a two-point mortise latch or lock, which may be used to engage a locking hook, via a central actuator. The central actuator is designed to simultaneously rotate two locking hooks via a linkage system. Prior art, as in U.S. Pat. No. 6,688,656 issued to Truth Hardware Corp., implement multi-point door locks with individual housing for each of their locking hooks. This type design is unduly difficult to manufacture and even more difficult to install. The two-point door latch of the present invention utilizes a linking system that implements a small amount of internal components, which allows for a simple cost effective manufacturing process. In addition, because the design of the present invention does not require large amounts of internal components, the size of the present invention, when compared to prior art, is relatively small, and thus easier to install. Furthermore, because the size of the present invention is small, the amount of material that must be bored from the stile of the door is much less then the amount that would have to be bored when installing other types of mortise locks. This is significant because the integrity of the door will not be compromised as much as with other prior art, i.e. the larger the configuration of the mortise lock the more door material that will have to be removed. The hooks of the present invention simultaneously pivot from a retracted deactivated position to an extended activated position. The simultaneous movement of the hooks is accomplished via hook arms and gear arms, which are pivotally connected. In addition, the central actuator and the gear wheel of the present invention are biased via springs.

### BRIEF DESCRIPTION OF INVENTION

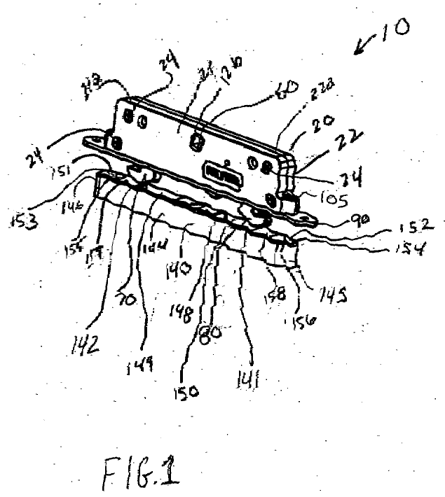

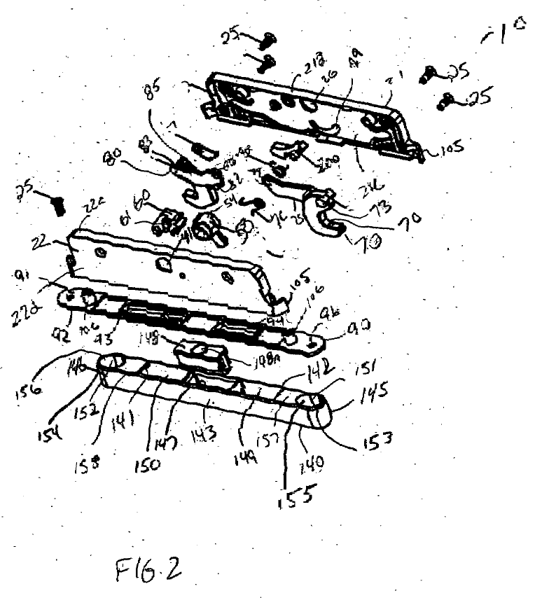

FIG. 1 is an expanded view of the two point mortise latch orientated above the keeper portion of the present invention.

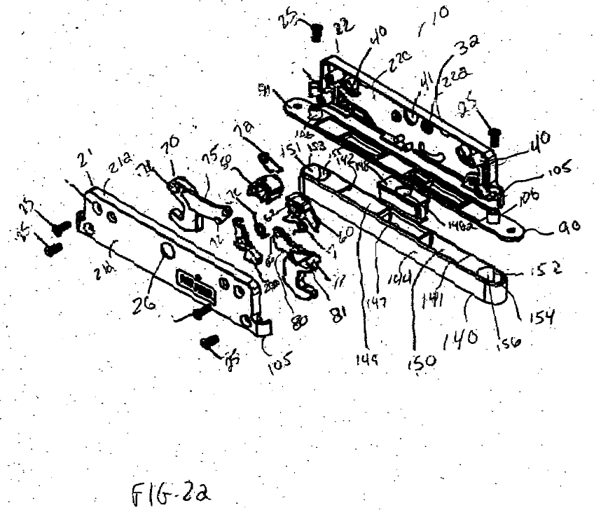

FIG. 2. is an exploded view of the two point mortise latch.

FIG. 2a is an opposite side view of FIG. 2.

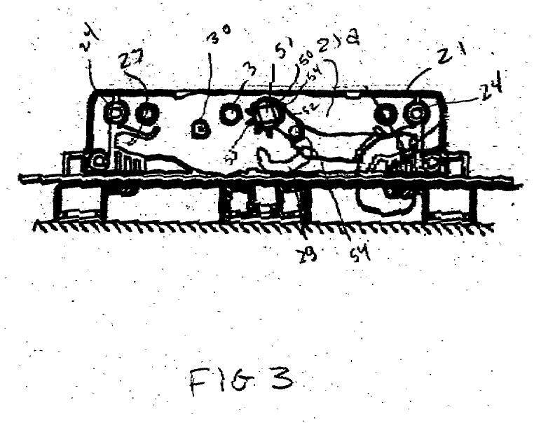

FIG. 3 is a side cutout view of the two point mortise latch assembly.

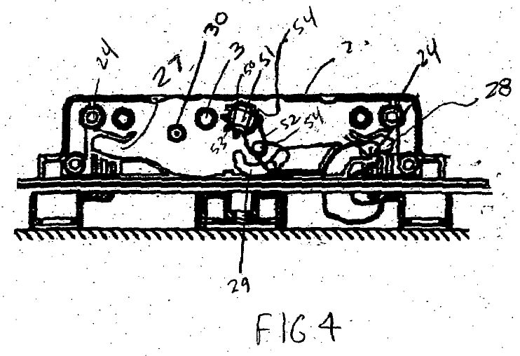

FIG. 4 is another side cutout view of the two point mortise latch assembly.

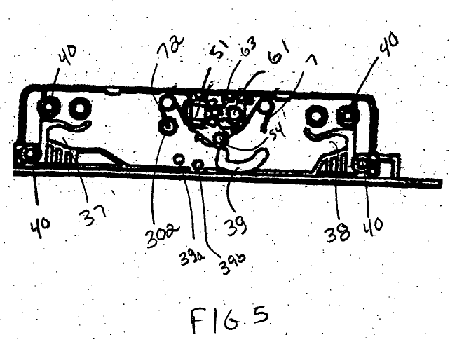

FIG. 5 is a side view of the two point mortise latch without the hooks.

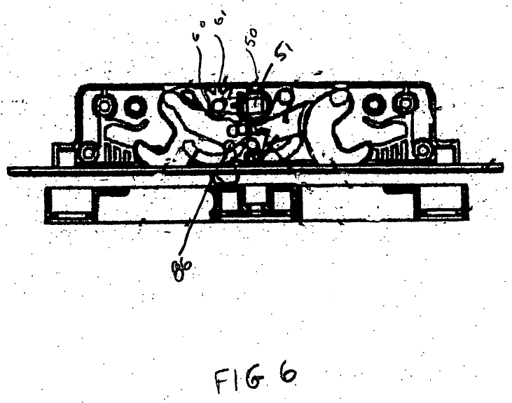

FIG. 6 is side view of the two point mortise latch assembly unlatched.

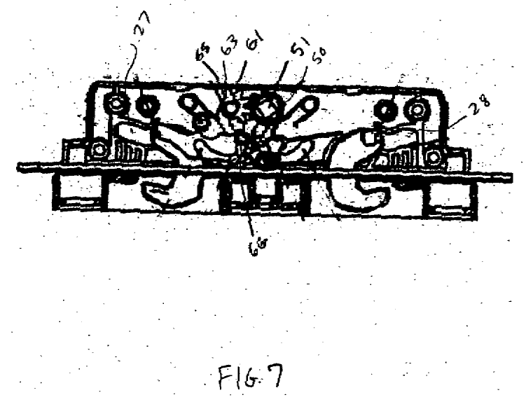

FIG. 7 is a side view of the two point mortise latch assembly with the hooks exposed.

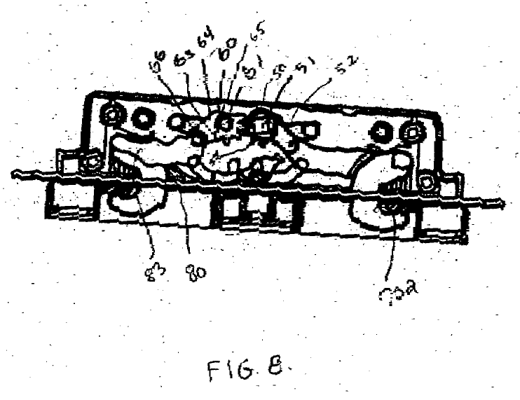

FIG. 8 is a side view of the two point mortise lock assembly latched.

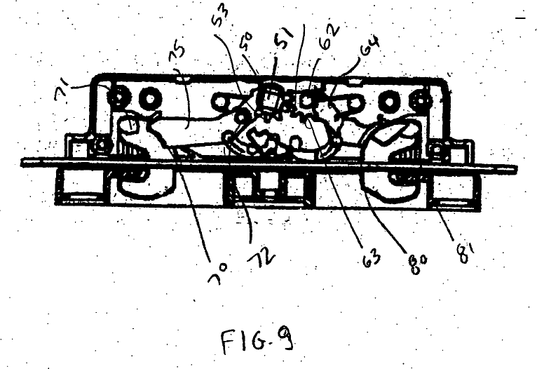

FIG. 9 is an opposite side view of FIG. 8, of the two point mortise latch assembly latched.

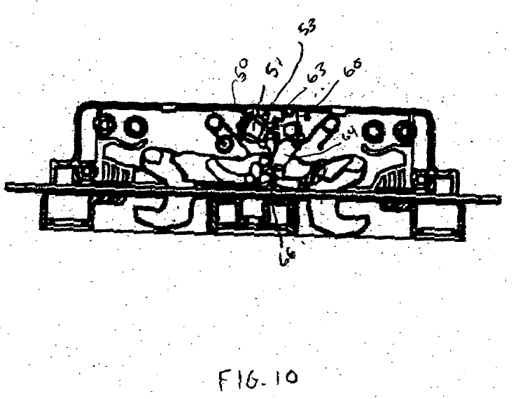

FIG. 10 is an opposite side view of FIG. 7, of the two point mortise latch assembly with the hooks exposed.

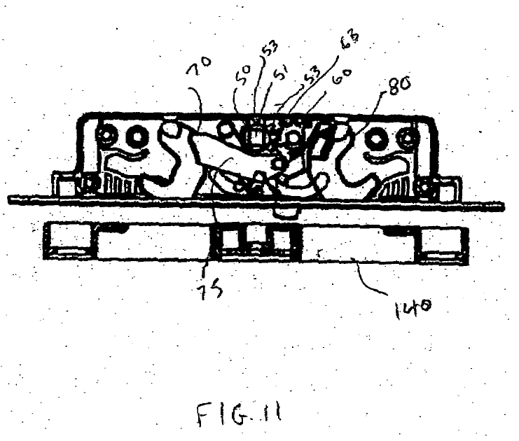

FIG. 11 is an opposite side view of FIG. 6, of the two point mortise latch assembly unlatched.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

FIG. 1 illustrates an exemplary embodiment of the instant invention wherein the main components of the two-point mortise door latch 10 for sliding glass doors generally include a central actuator 50, two hooks, 70 and 80, which are in an opposed orientation in relation to each other, and a housing 20. Hooks 70 and 80 each may have linkage lever arms 75 and 85 respectively, attached to a hub portion of both hooks. Another component of the two-point mortise latch 10 is keeper housing 140, which may contain at least one keeper 141. In the preferred embodiment one implemented an upper and lower keeper, 141 and 142 respectively, as seen in FIGS. 1, 2, 2a. All components of the present invention may be made from any suitable material known in the art including but not limited to metal,.metal alloy, industrial strength plastics and the like. In the preferred embodiment one implemented a variety of elemental metals and metal alloys for all parts of the present invention.

Turning again to FIG. 1, two-point mortise lock includes a-housing assembly 20 that houses the necessary components of the present invention. Housing 20 may have a first sidewall 21 and a second sidewall 22 that may be connected by any suitable known connection method known in the art including but not limited to screws, pins, and the like. In the preferred embodiment screws 25 were implemented, as seen in FIGS. 2 and 2a. First and second sidewall members 21 and 22, respectively, may have top surfaces, 21a and 22a, respectively, and bottom surfaces 21b and 22b, respectively, as seen in FIGS. 2 and 2a In addition, sidewall members 21 and 22 may have inner surfaces 21c and 22c, respectively, and outer surfaces, 21d and 22d, respectively. Sidewall members 21 and 22 may have different apertures, protrusions, and grooves located on their respective inner and outer surfaces. For example, inner surfaces 21c may have four apertures 24, for receiving fasteners 25. In one embodiment apertures 24 may be flushed with inner surface 21c, or as in the preferred embodiment aperture 24 may extend in a generally perpendicular direction from inner surface 21c to form a recessed protrusion, as seen in FIGS. 3 and 4. Apertures 24 may extend from outer surface 21d of sidewall member 21 to inner surface 21d of sidewall 21. One skilled in the art will appreciate that aperture 24 may be generally sized and shaped to be able to receive fastener 25. Sidewall member 21 may also have a generally circular aperture 26 located near its top center. Aperture 26 also extends from outer surface 21d to inner surface 21c. It will be appreciated by one skilled in the art that aperture 26 will be generally sized to receive central actuator 50. In addition to having apertures 24 and 26, inner surface 21c of sidewall member 21 may have grooves located thereto, as mentioned above. For example, inner surface 21c may have a generally circular bored groove 3 located near the vicinity of aperture 26, which may be used to receive top protrusion 61 of gear member 60, as seen in FIGS. 3 and 4 Inner surface 21c of sidewall member 21 may also have guide regions 27 and 28. Guide regions 27 and 28 retain protrusions 71 and 81 of hooks 70 and 80 respectively, as seen in FIGS. 3 and 4. Inner sidewall 21c of side member 21 may also have a generally semi-parabolic shaped bored cavity 29 to receive and retain protrusion 72 of hook member 70. Inner surface 21c of sidewall 21 may also have a generally circular protrusion 30 extending perpendicularly from inner surface 21c. Protrusion 30 may have an aperture located near its center for receiving a portion of a resilient member 7.

In normal operation sidewall member 21 will serve as one half of housing 20. In addition, sidewall 21 will allow hooks 70 and 80 to traverse from a retracted deactivated position to an extended activated position, via guide regions 27, 28, and semi-parabolic bored cavity 29.

As mentioned above housing 20 may be formed by sidewall 21 and sidewall 22. Turning one's attention now to FIGS. 1, 2, and 2a, one will discuss the elements of sidewall 22.

As in sidewall member 21, sidewall member 22 may have different grooves, cavities, protrusions and apertures. Inner surface 22c of sidewall member 22 may have four protrusions 40. Protrusions 40 may be of any suitable shape known in the art including but not limited to a circle, square, or the like. In the preferred embodiment one implemented four generally cylindrical protrusions. Protrusions 40 may extend in a generally perpendicular direction from inner surface 22c of sidewall member 22. One skilled in the art will appreciate that protrusion 40 may be generally sized and shaped to be able to receive fastener 25. In addition protrusion 40 may be threaded or smooth. In the preferred embodiment one implemented threaded protrusions so as to be able to receive threaded fasteners 25. Sidewall member 22 may also have a generally circular aperture 41 located near its top center area. Aperture 41 also extends from outer surface 22d to inner surface 22c. It will be appreciated by one skilled in the art that aperture 41 will be generally sized to receive central actuator 50. In addition to having protrusions 40 inner surface 22c of sidewall member 22 may have grooves located thereto, as mentioned above. For example, inner surface 22c may have a generally circular bored groove 3a located near the vicinity of aperture 41, which may be used to receive bottom protrusion 62 of gear member 60. Inner surface 22c of sidewall member 22 may also have guide regions 37 and 38. Guide regions 37 and 38 retain protrusions 73 and 83 of hooks 70 and 80 respectively, as seen in FIG. 5. Inner sidewall 22c of side member 22 may also have a generally semi-parabolic shaped bored cavity 39 to receive and retain protrusion 82 of hook member 80. Inner surface 22c of sidewall 22 may also have a generally circular protrusion 30a extending perpendicularly from inner surface 22c. Protrusion 30a may have an aperture located near its center for receiving a portion of a resilient member 7a. Inner surface 22c may also have two cylindrical posts adjacent to each other 39a and 39b, which act as retainers for release lever 200.

Sidewalls 21 and 22 may each have two half sleeves 105 located adjacent to side surfaces 21b and 22b, as seen in FIG. 1. In normal operation when sidewalls 21 and 22 are connected, half sleeves 105 will join to form two full sleeves, as seen in FIGS. 1, 2, and 2a so as to be able to receive at least one screw and house at least one protrusion 106, as seen in FIG. 2.

Housing 20, as mentioned above, may have a faceplate 90, which may be used to enclose housing 20. Faceplate 90 may be of generally rectangular shape with generally rounded front and rear ends, as seen in FIG. 1. Faceplate 90 may have a top inner surface and a lower outer surface, 91 and 92 respectively. Faceplate 90 may have at least one access aperture located near the center of faceplate 90. In the preferred embodiment faceplate 90 had top and bottom access apertures, 93 and 94 respectively, as seen in FIG. 2. Access apertures 93 and 94, allow hooks 70 and 80, to pivot from a retracted open position to an extended closed position, as seen in FIGS. 2, 4, 5, and 6. In addition, one may also have at least one aperture 96 located near the center, of rounded front and rear ends. In the preferred embodiment one implemented two generally circular apertures 96. Apertures 96 may be used for mounting two-point mortise lock 10 to the stile of a sliding door member. As mentioned previously, one may also have at least one protrusion located on faceplate 90. In the preferred embodiment one implemented two generally cylindrical threaded protrusions 106. It will be appreciated by those skilled in the art that one may implement protrusions of any geometrical shape and size, and such protrusions may or may not be threaded; depending on the fastening method implemented. Protrusions 106 may extend in a generally perpendicular direction in reference to plane of top inner surface 91. As mentioned previously, one may attach faceplate 90 to housing 20 by any suitable attachment methods known in the art including but not limited to adhesives, screws, or the like. In the preferred embodiment one implemented two screws similar to those used to attach sidewalls 21 and sidewalls 22. After sidewalls 21 and 22 are connected, half sleeves of sidewalls 21 and 22 will form full sleeve 105, thus forming a tight fit over cylindrical protrusions 106, so as to display a smooth aesthetically pleasing appearance to the user. Generally, before installation, a recess of suitable dimensions may be bored into stile of sliding door. After assembly, housing 20 of two-point mortise lock 10 may be placed inside of recess and mounted to stile of sliding door, via screws 25.

Turning one's attention again to FIGS. 1 and 2 one will describe keeper housing 140 in more detail. Keeper housing 140 may be of generally the same shape as faceplate 90. Keeper housing 140 may have sidewalls 143 and 144, along with generally rounded front and rear ends, 145 and 146 respectively. It will be appreciated by one skilled in the art that the dimensions of keeper housing 140 will be such that hooks 70 and 80 will be able to pivot from an open retracted position to a closed extended position. Located near the center of keeper housing 140 may be a cavity 147. Cavity 147 may be of such dimensions so as to be able to receive reinforcing member 148, as seen in FIG. 1. Reinforcing member 148 may be of generally rectangular shape with an aperture 148a located near its center, aperture 148a may be implemented to facilitate mounting keeper housing 140 to the jamb of the sliding door. Keeper housing 140 may also have at least one aperture located on its front surface. In the preferred embodiment one implemented upper and lower apertures, 149 and 150 respectively. Apertures 149 and 150 may be used to receive hooks 70 and 80, respectively. As mentioned above faceplate 140 may have generally rounded front and rear ends, 145 and 146 respectively. Font and rear ends also may have front and rear apertures, 151 and 152 respectively, as seen in FIGS. 1, 2, and 8. Apertures 151 and 152 may be defined with generally circumferential outer top edges 153 and 154 respectively, and generally circumferential inner surfaces 155 and 156 respectively. Apertures 155 and 156 may be used to receive fastening means, such as a screw or the like, for mounting keeper housing 140 to jamb of door. Extending from outer top edges in a direction toward the center may be surfaces 157 and 158. Surfaces 157 and 158 may extend a distance that will allow hooks 70 and 80 to retract and extend into apertures 149 and 150 of keeper housing 140. In addition, surfaces 157 and 158 may act as keepers for hooks 70 and 80 respectively, as in the preferred embodiment. Surfaces 157 and 158 may be smooth, or ribbed, depending on the desired finished look. In normal operation the outer surface of hooks 70 and 80 may contact the bottom surfaces 159 and 160 of surfaces 157 and 158 respectively, thus preventing opening of the door.

If a different finished look is desired-.by the user one may implement a variety of other different keeper techniques. It will be appreciated by one skilled in the art that one may use any type of suitable keeper known in the art including but not limited to a bar, bolt, pin, rod, or the like. For example, in a different embodiment one may implement two generally cylindrical keeper bars that may extend from a first sidewall to a second sidewall of keeper housing 140.

In normal operation, no matter which embodiment of the present invention is implemented, keeper housing 140 will be installed inside of a bored cavity located in doorjamb. The location of keeper housing 140, inside of doorjamb, will depend on the location of the two-point mortise lock, i.e. the two members will be aligned so that apertures 149 and 150 of keeper housing 140 may receive of hooks 70 and 80a of two-point mortise lock.

A detailed description of the internal components will now be discussed. Referring to FIG. 1 one may view the internal components of the present invention. Located near the center of housing 20 may be aperture 126. Aperture 126 is formed by connecting sidewall 21 and sidewall 22, i.e. placing apertures 26 and 41 along the same central axis of rotation. Aperture 126 may be implemented to retain central actuator 50.

Central actuator 50 may be generally cylindrical in shape with an aperture 51 located near its center. Aperture 51 may be any suitable known shape in the art; in the preferred embodiment one implemented a generally square aperture. Aperture 51 may be used to receive the tail end of a turning mechanism, such as a key. In another embodiment of the present invention, central actuator 50 may have a lever attached, thus no key would be needed to open or close the door, and one would simply turn the lever to retract or extend hooks 70 and 80. Located on the outer, generally circumferential surface, of central actuator 50 may be teeth 53. Teeth 53 mesh with teeth 63 of gear 60, as seen in FIGS. 5, 6, and 7. In addition central actuator 50 may have an arm 52 that may extend tangentially from generally outer circumferential surface 54 of central actuator 50. Located on and extending from the top surface of arm 52 of central actuator 50 may be a protrusion 54. Protrusion 54 may be of any suitable structures known in the art including but not limited to a peg, pin, or the like. In the preferred embodiment one implemented a generally cylindrical shaped post 54. Post 54 may be a separately attached member or post 54 may be integrally formed with actuator 50. In the preferred embodiment post 54 was integrally formed so as to increase the integrity of the door latch. Central actuator 50 may also have an aperture 56 located on bottom surface of arm 52. It will be appreciated by those skilled in the art that aperture 56 may be of such dimensions so as to retain a portion of a resilient member 7a. In normal operation post 55 is retained inside of aperture 74, as seen in FIG. 2, located on arm 75 of hook 70, thus forming one part of the linkage system of the present invention. As mentioned above central actuator 50 may be biased with resilient member 7a. Any type of suitable resilient member known in the art including but not limited to a spring, band, or the like may be implemented. In the preferred embodiment one implemented a coil spring.

As mentioned above, central actuator 50 co-acts with hook 70, via the linkage system, and co-acts with gear 60, via meshing of teeth 53 and teeth 63. Gear 60 is of generally the same shape as central actuator 50, however, as mentioned previously, gear 60 has top and bottom protrusions 61 and 62, respectively. In addition gear 60 may have an arm 64 that may extend tangentially from generally outer circumferential surface 65 of gear 60. Located on and extending from the top surface of arm 64 of gear 60 may be a protrusion 66. Protrusion 66 may be of any suitable structures known in the art including but not limited to a peg, pin, or the like. In the preferred embodiment one implemented a generally cylindrical shaped post 66. Post 66 may be a separately attached member or post 66 may be integrally formed with gear 60. In the preferred embodiment post 66 was integrally formed so as to increase the integrity of the door latch. Gear 60 may also have an aperture 67 located on bottom surface of arm 64. It will be appreciated by those skilled in the art that aperture 67 may be of such dimensions so as to retain a portion of a resilient member 7b. In normal operation post 66 is retained inside of aperture 86 located on arm 85 of hook 80, thus forming the other part of the linkage system of the present invention. As mentioned above gear 60 may be biased with resilient member 7. Any type of suitable resilient member known in the art including but not limited to a spring, band, or the like may be implemented. In the preferred embodiment one implemented a coil spring.

In normal operation when the user desires to open or lock the door the user may insert a turning mechanism and rotate central actuator 50. The rotation of central actuator 50 will cause hook 70 to traverse inside guide member via the linkage system.

A more detailed description of hooks 70 and 80 will now be discussed. One will first discuss hook 70, since it is connected to central actuator 50. Hook 70 may have a generally “C” shaped locking portion 70a and an arm portion 75, as mentioned previously. In addition hook 70 may have protrusions, or pins 71 and 73 that are retained in guide areas 27 and 37 respectively, and protrusion, or pin 72, which is retained in semi-parabolic grooved region 29. In addition hook 80 may have protrusion or pin 82, which may serve the same function as pin 72 of hook 70, except pin 82 of hook 80 will be retained inside semi-parabolic region 39 of sidewall 22. In one embodiment arm portion 75 of hook 70 may have a length that is slightly longer then that of arm portion 85 of hook 80. This length differential allows for maximum pivot capability inside of housing 20. In another embodiment one may have arm portions 75 and 85 equal in length. As mentioned previously hooks 70 and 80 may have protrusions 71, 73, and 72, and 80, 83, and 81, respectively. In one embodiment one may have arms 75 and 85 integrally formed with protrusions 71 and 83, respectively, or as in the preferred embodiment one may have only arm 85 of hook 80 integrally formed with protrusion 83. If one implements this type of configuration, it will also allow for maximum pivot capability inside of housing 20.

In the present invention keeper portion 140 may be mounted to the side of a door jamb with or without a gasket. If one desired to mount keeper housing 140 with a gasket, as in the preferred embodiment, any suitable gasket known in the art including, but not limited to paper, rubber, silicone, metal, felt, fiberglass, plastic polymers or the like. In the preferred embodiment one implemented a plastic polymer.

In normal operation when the user desires to open or close the sliding door the user will turn central actuator 50, via a key member or a lever member. The rotational movement of central actuator 50 will cause teeth 53 of central actuator 50 and teeth 63 of gear 60 to rotate, which in turn will cause a translational movement of arms 75 and 85 of hooks 70 and 80, respectively, to pivot, thus causing protrusions 71, 73, and 72 of hook 70, to traverse inside of guide areas 27, 37, and 29, respectively. In addition protrusions 81, 83, and 82 of hook 80, will traverse inside guide areas 28, 38, and 39, respectively. This co-action between central actuator 50, gear wheel 60, and arms 75 and 85 of hooks 70 and 80 respectively will cause both hooks to simultaneously pivot outwardly to a latched position, via contacting surfaces 159 and 160 of surfaces 157 and 158, and inwardly to an unlatched position.

As various changes could be made in the above constructions without departing from the scope of the invention, it is intended that all matter contained in the above description shall be interpreted as illustrative and not in a limiting sense. In the view above it will be seen that several objects of the invention are achieved and other advantageous results attained.

I claim:

1. An improved door latch for a sliding door; said door having an opening in a lock face of a stile of said door, said latch comprising a housing, said housing having a first sidewall portion and a second sidewall portion;
said housing having a first hook and a second hook pivotally mounted in said housing, each of said hooks having a first end for latching to a keeper on a jamb and a second end that is positioned in a guide area on an inner surface of said sidewall portion said hook having an arm extending therefrom, said hooks being adapted to move between a retracted position and an extended latched position; and
an actuator, said actuator having an orifice for receiving a tail member, said actuator having an arm extending from a sidewall thereof, said arm being pivotally connected to said arm extending from said first hook, said actuator having a plurality of teeth extending from said sidewall of said actuator, said teeth meshing with a gear wheel, said gear wheel having an arm extending from a sidewall of said gear wheel, said arm of said gear wheel being pivotally connected to said arm of said second hook, said actuator moving said hooks from a latched position to an unlatched position and from an unlatched position to a latched position as said tail member is turned.

2. The latch according to claim 1 wherein said actuator arm has a top surface and a bottom surface and one of said surfaces has a pin extending therefrom, said pin being received in an orifice in said arm of said first hook.

3. The latch according to claim 1 wherein said actuator arm has a top surface and a bottom surface and one of said surfaces has an orifice, said first hook having a top surface and a bottom surface wherein one of said surfaces has a pin extending therefrom, said pin bring received in said orifice of said actuator.

4. The latch according to claim 1 wherein at least one of said teeth of said actuator also extends from a top or bottom surface of said arm.

5. The latch according to claim 2 wherein at least one of said teeth of said actuator also extends from a top or bottom surface of said arm.

6. The latch according to claim 3 wherein at least one of said teeth of said actuator also extends from a top or bottom surface of said arm.

7. The latch according to claim 2 wherein said side wall has a ring portion extending from at least a portion of said sidewall.

8. The latch according to claim 7 wherein said ring portion has a top surface and a bottom surface and wherein one of said surfaces has an orifice for receiving an end of said spring.

9. The latch according to claim 8 wherein said actuator is positioned in an orifice in each sidewall portion of said housing.

10. The latch according top claim 8 wherein the other end of said spring is received by an aperture in and inside surface of said sidewall portion.

11. The latch according to claim 1 wherein said gear wheel arm has a top surface and a bottom surface and one of said surfaces has a pin extending therefrom, said pin being received in an orifice in said arm of said second hook.

12. The latch according to claim 1 wherein said gear wheel arm has a top and a bottom surface and one of said surfaces has an orifice, said second hook having a top surface and a bottom surface wherein one of said surfaces has a pin extending therefrom, said pin bring received in said orifice of gear wheel arm.

13. The latch according to claim 11 wherein said gear wheel has a top surface and a bottom surface, said top and bottom surfaces having a pin extending therefrom.

14. The latch according to claim 13 wherein each inside surface of said side wall portion has a raised ring for receiving said pins of said gear wheel and permitting said gear wheel to pivot as said actuator pivots.

15. The latch according to claim 13 wherein said arm of said gear wheel has a top surface and a bottom surface and wherein one of said surfaces has an aperture for receiving an end of a spring.

16. The latch according top claim 15 wherein the other end of said spring is received by an aperture in and inside surface of said sidewall portion.

17. The latch according to claim 1 wherein said first hook has a first end that extends from said housing when said first hook is in an extended position and a second end having a pin extending from a top and bottom surface of said first hook, said pins being received in a groove in an inside surface of said sidewall position.

18. The latch according to claim 1 wherein said first hook has a first end that extends from said housing when said first hook is in an extended position and a second end having an orifice therein, said orifice receives pins extending from said inside surfaces of said sidewall portions.

19. The latch according to claim 17 wherein said groove is formed by an inside surface of said sidewall portion and at least a first ridge extending from said inside surface and a second ridge extending from said inside surface said groove having an open end and a closed end formed by said ridges.

20. The latch assembly according to claim 18 wherein at least one of said ridges has one or more teeth that contact a side of said pin.

21. The latch according to claim 1 wherein said second hook has a first end that extends from said housing when said second hook is in an extended position and a second end having a pin extending from a top and bottom surface of said second hook, said pins being received in a groove in an inside surface of said sidewall portion.

22. The latch according to claim 1 wherein said second hook has a first end that extends from said housing when said second hook is in an extended position and a second end having an orifice therein, said orifice receives pins extending from said inside surfaces of said sidewall portions.

23. The latch according to claim 21 wherein said groove is formed by an inside surface of said sidewall portion and at least a first ridge extending from said inside surface and a second ridge extending from said inside surface said groove having an open end and a closed end formed by said ridges.

24. The latch assembly according to claim 23 wherein at least one of said ridges has one or more teeth that contact a side of said pin.

25. The latch according to claim 1 wherein said first hook has a first end that extends from said housing when said first hook is in an extended position and a second end having a pin extending from a top and bottom surface of said first hook, said pins being received in a groove in an inside surface of said sidewall position; and
said second hook has a first end that extends from said housing when said second hook is in an extended position and a second end having a pin extending from a top and bottom surface of said second hook, said pins being received in a groove in an inside surface of said sidewall position.

26. The latch according to claim 25 wherein said groove is formed by an inside surface of said sidewall portion and at least a first ridge extending from said inside surface and a second ridge extending from said inside surface said groove having an open end and a closed end formed by said ridges.

27. The latch assembly according to claim 26 wherein at least one of said ridges has one or more teeth that contact a sidewall of said pin.

28. The latch according to claim 1 wherein said keeper has a top exterior surface and a top interior surface and first and second sidewalls extending from said top surface, said top surface having a first and second orifice therethrough for receiving said hooks and wherein a surface of said hooks contacts said top interior surface of said keeper housing when said hooks are in an extended position.
